(19) United States
(12) Patent Application Publication
(10) Pub. No.: US 2013/0047948 A1
(43) Pub. Date: Feb. 28, 2013

(54) PISTON FOR AN INTERNAL COMBUSTION ENGINE

(71) Applicant: Urs HEUSCHMANN, Leonberg (DE)

(72) Inventor: Urs HEUSCHMANN, Leonberg (DE)

(73) Assignee: MAHLE INTERNATIONAL GMBH, Stuttgart (DE)

(21) Appl. No.: 13/238,043

(22) Filed: Sep. 21, 2011

(30) Foreign Application Priority Data
Aug. 26, 2011 (DE) 10 2011 111 319.7

(51) Int. Cl. F02F 3/00

(52) U.S. Cl. 123/193.6

(57) ABSTRACT

A piston for an internal combustion engine has a piston crown, a circumferential ring belt, a circumferential cooling channel in the region of the ring belt, pin boss supports connected below the piston crown, and pin bosses connected with the pin boss supports, as well as a piston skirt. A cavity closed all around is provided below the piston crown and a coolant in the form of a metal or metal alloy having a low melting point is accommodated in the cavity.

### CROSS REFERENCE TO RELATED APPLICATIONS

Applicant claims priority under 35 U.S.C. §119 of German Application No. 10 2011 111 319.7 filed Aug. 26, 2011, the disclosure of which is incorporated by reference.

### BACKGROUND OF THE INVENTION

1. Field of the Invention

The present invention relates to a piston for an internal combustion engine, which has a piston crown, a circumferential ring belt, a circumferential cooling channel in the region of the ring belt, pin boss supports connected below the piston crown, and pin bosses connected with them, as well as a piston skirt. A cavity closed all around is provided below the piston crown.

2. The Prior Art

A piston of this type is described in German Patent Application No. DE 10 2010 009 891.4. In this piston, the circumferential cooling channel serves to control the temperature in the outer region of the piston crown, for example along the edge of a combustion bowl, during engine operation. There, the temperature should not rise above 550° C., in order not to impair the component strength of the piston. On the other hand, the temperature should not be significantly lower, in order to achieve the greatest possible combustion and exhaust gas temperature and thus a good degree of efficacy of the internal combustion engine.

The cavity that is closed all around, below the piston crown, controls the temperature in the central region of the piston crown, for example the inner region of a combustion bowl, during engine operation. In this region, the temperature should lie approximately between 230° C. and 330° C. during engine operation.

In the case of the piston of the stated type, only air is enclosed in the closed cavity, so that influencing the temperature in the central region of the piston crown is not possible.

### SUMMARY OF THE INVENTION

It is therefore an object of the present invention to develop a piston in such a manner that influencing the temperature in the central region of the piston crown, during engine operation, is made possible.

This object is accomplished in that a coolant in the form of a metal having a low melting point, or a metal alloy having a low melting point, is accommodated in the cavity.

The principle underlying the present invention consists in influencing the temperature in the central region of the piston crown, during engine operation, by means of a metallic coolant that is liquid during engine operation and has good heat conductivity. The greater the heat conductivity of the coolant, and the greater the amount of coolant enclosed in the cavity, the more heat is conducted away from the piston crown, in the direction of the piston interior. Thus, the temperature in the central region of the piston crown can be influenced by way of the amount of coolant used and/or by way of its heat conductivity, i.e. by way of the selection of the coolant material.

The present invention is suitable for all piston types, i.e. for one-part and multi-part pistons, as well as for pistons having a low construction height. The piston according to the invention has great stability, because no cooling oil channels between the outer cooling channel and the inner cavity, which have a destabilizing effect, as locations of the greatest stress concentration, are provided.

Metals having a low melting point, which are suitable for use as coolants, are, in particular, sodium or potassium. Metal alloys having a low melting point that can be used are, in particular, Galinstan® alloys, bismuth alloys having a low melting point, and sodium-potassium alloys.

Alloy systems composed of gallium, indium, and tin are referred to as so-called Galinstan® alloys; they are liquid at room temperature. These alloys consist of 65 wt.-% to 95 wt.-% gallium, 5 wt.-% to 26 wt.-% indium, and 0 wt.-% to 16 wt.-% tin. Preferred alloys are, for example, those with 68 wt.-% to 69 wt.-% gallium, 21 wt.-% to 22 wt.-% indium, and 9.5 wt.-% to 10.5 wt.-% tin (melting point −19° C.), 62 wt.-% gallium, 22 wt.-% indium, and 16 wt.-% tin (melting point 10.7° C.), as well as 59.6 wt.-% gallium, 26 wt.-% indium, and 14.4 wt.-% tin (ternary eutectic, melting point 11° C.)

Bismuth alloys having a low melting point are known in numerous forms. These include, for example, LBE (eutectic bismuth-lead alloy, melting point 124° C.), Rose's metal (50 wt.-% bismuth, 28 wt.-% lead, and 22 wt.-% tin, melting point 98° C.), Orion metal (42 wt.-% bismuth, 42 wt.-% lead, and 16 wt.-% tin, melting point 108° C.), fast solder (52 wt.-% bismuth, 32 wt.-% lead, and 16 wt.-% tin, melting point 96° C.), d'Arcet's metal (50 wt.-% bismuth, 25 wt.-% lead, and 25 wt.-% tin), Wood's metal (50 wt.-% bismuth, 25 wt.-% lead, 12.5 wt.-% tin, and 12.5 wt.-% cadmium, melting point 71° C.), Lipowitz' metal (50 wt.-% bismuth, 278 wt.-% lead, 13 wt.-% tin, and 10 wt.-% cadmium, melting point 70° C.), Harper's metal (44 wt.-% bismuth, 25 wt.-% lead, 25 wt.-% tin, and 6 wt.-% cadmium, melting point 75° C.), Cerrolow 117 (44.7 wt.-% bismuth, 22.6 wt.-% lead, 19.1 wt.-% indium, 8.3 wt.-% tin, and 5.3 wt.-% cadmium, melting point 47° C.), Cerrolow 174 (57 wt.-% bismuth, 26 wt.-% indium, 17 wt.-% tin, melting point 78.9° C.), Field's metal (32 wt.-% bismuth, 51 wt.-% indium, 17 wt.-% tin, melting point 62° C.), as well as the Walker alloy (45 wt.-% bismuth, 28 wt.-% lead, 22 wt.-% tin, and 5 wt.-% antimony).

Suitable sodium-potassium alloys can contain 40 wt.-% to 90 wt.-% potassium. The eutectic alloy NaK with 78 wt.-% potassium and 22 wt.-% sodium (melting point −12.6° C.) is particularly suitable.

The amount of the coolant accommodated in the cavity depends on its heat conductivity and the degree of the desired temperature control. Preferably, the volume of the coolant accommodated in the cavity amounts to at most 10% of the volume of the cavity. This has the additional advantage that the coolant is subject to the so-called Shaker effect during engine operation, in that it is moved counter to the stroke direction of the piston in the cavity. During the downward stroke of the piston, the coolant is moved in the direction of the piston crown and can then absorb heat. During the upward stroke of the piston, the coolant is moved in the direction of the piston skirt, and can thus give off the heat it has absorbed, in the direction of the piston skirt. The cooling effect is further improved in this way.

In a preferred further development, a combustion bowl composed of a heat-resistant steel or a nickel-based alloy can be provided in the piston crown, in order to increase the temperature resistance of the piston according to the invention. The use of a nickel-based alloy has the further advantage that the corrosion resistance of the piston according to the invention is further increased.

In a corresponding manner, the entire piston crown can consist of a heat-resistant steel or a nickel-based alloy. In addition, at least a part of the circumferential ring belt can consist of a heat-resistant steel or a nickel-based alloy.

The piston according to the invention can be configured as a one-part piston, for example a cast piston. The piston according to the invention can furthermore be configured as a multi-part piston, for example assembled from an upper piston part and a lower piston part. The components can be cast parts or forged parts, for example, and can be produced, particularly forged, from a steel material or a nickel-based alloy. The connection between the components can be made in any desired manner, for example by means of welding, screws, or soldering. Welding methods, particularly friction-welding methods and laser-welding methods, are particularly suitable as joining methods.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a section through a first embodiment of a piston according to the invention;

FIG. 2 shows a section through another embodiment of a piston according to the invention; and

FIG. 3 shows a section through another embodiment of a piston according to the invention.

### DETAILED DESCRIPTION OF THE PREFERRED EMBODIMENT

In the following, the present invention will be described using a two-part piston. Of course, the present invention can also be implemented with other suitable piston types.

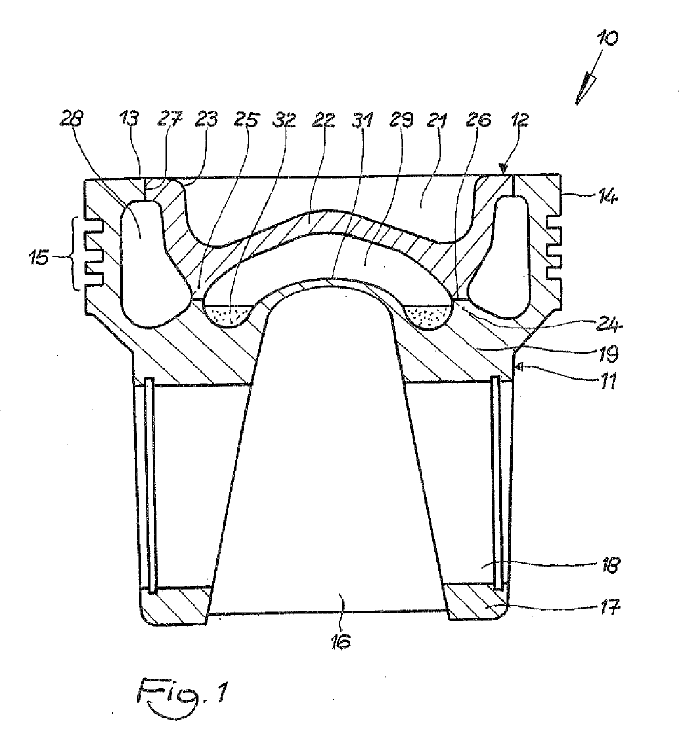

FIG. 1 shows a first exemplary embodiment of a piston 10 according to the invention, in the form of a box piston. Piston 10 according to the invention is composed of a piston base body 11 and a piston crown element 12. Piston base body 11 is forged from a steel material, while piston crown element 12 is produced from a steel material resistant to high heat, or from a nickel-based alloy.

Piston base body 11 has a part of a piston crown 13, a circumferential top land 14, and a circumferential ring belt 15. Piston base body 11 furthermore has a piston skirt 16 as well as pin bosses 17 having pin bores 18 for accommodating a piston pin (not shown). Pin bosses 17 are connected with underside 13′ of piston crown 13 by way of pin boss supports 19.

Piston crown element 12 has a part of a piston skirt 13 with a combustion bowl 21. Combustion bowl 21 has a bowl bottom 22 and a circumferential bowl edge 23.

Piston base body 11 has an inner circumferential support element 24, while piston crown element 12 has a corresponding inner circumferential support element 25. The two support elements 24, 25 stand in contact with one another by way of joining surfaces. Piston base body 11 furthermore has a further joining surface in the region of top land 14, which surface stands in contact with a corresponding joining surface in the region of bowl edge 23 of piston crown element 12.

Piston base body 11 and piston crown element 12 can be joined together in any desired manner, whereby the corresponding joining surfaces of piston base body 11 and of piston crown element 12 are connected with one another. In the exemplary embodiment, a welding method was selected, so that piston base body 11 and piston crown element 12 are connected with one another by way of joining seams 26, 27.

Piston base body 11 and piston crown element 12 form a circumferential cooling channel 28, which is supplied with cooling oil in known manner, as can be seen in FIG. 1. Piston base body 11 and piston crown element 12 furthermore form a cavity 29 that is disposed essentially below bowl bottom 22 in the exemplary embodiment.

Cavity 29 is closed off on all sides, in other words piston base body 11 and piston crown element 12 have no kinds of openings such as cooling oil channels, for example, which connect outer cooling channel 28 with cavity 29. In order to close off cavity 29 in the direction of the piston skirt 16 and of pin bosses 17, a closure element 31 is provided. In the exemplary embodiment, closure element 31 is a closure wall configured in one piece with piston base body 11, which wall is connected with piston base body 11, in one piece, in a region of pin boss supports 19, so that no lubricant oil can exit from the crankcase and no cooling oil can exit from cooling channel 28, respectively, and penetrate into cavity 29.

A coolant 32 in the form of a metal having a low melting point or a metal alloy having a low melting point, such as those listed as examples above, is disposed in cavity 29. The volume of liquid coolant 32 amounts to about 5% to 10% of the volume of cavity 29 in the exemplary embodiment.

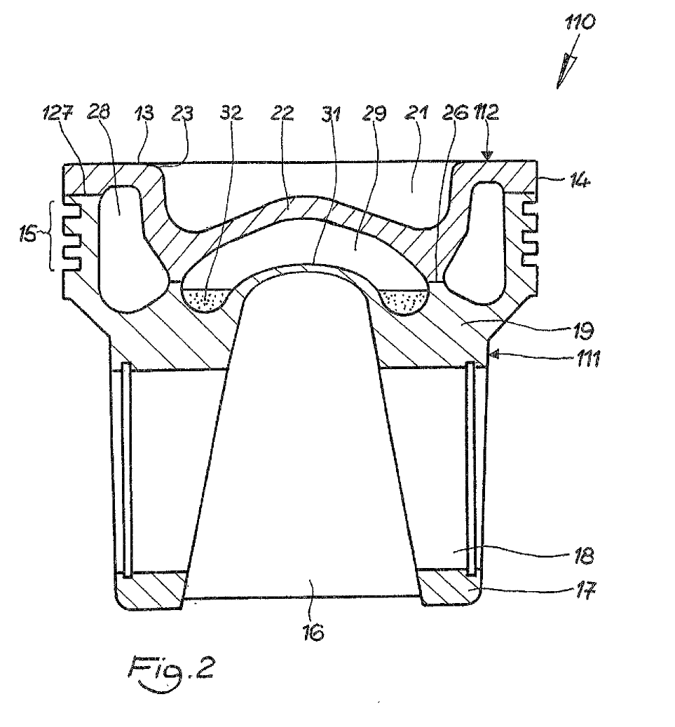

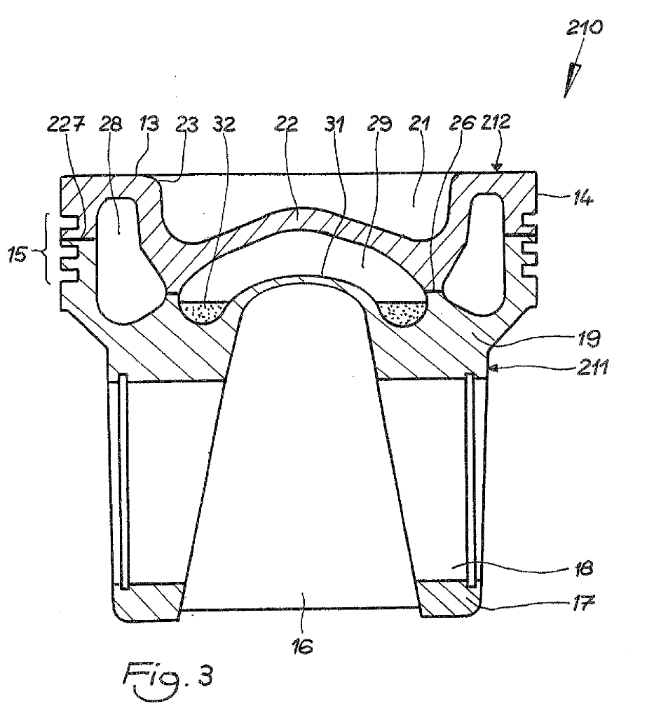

FIGS. 2 and 3 show other exemplary embodiments of a piston 110 and 210, respectively, according to the invention, which differ only in the configuration of piston base bodies 111 and 211, respectively, and of piston crown elements 112, 212.

Piston 110 according to FIG. 2 has a piston crown element 112 composed of a steel resistant to high heat, or a nickel-based alloy, which comprises the entire piston crown 13. Piston base body 111 and piston crown element 112 are thus connected with one another, in the region of piston crown 13, by way of a joining seam 127, which runs horizontally through top land 14 above ring belt 15. With regard to the further structure of the piston 110 and its function, reference is made to the description regarding FIG. 1.

Piston 210 according to FIG. 3 has a piston crown element 212 composed of a steel resistant to high heat, or of a nickel-based alloy, which comprises the entire piston crown 13, top land 14, and part of ring belt 15. Piston base body 211 and piston crown element 212 are therefore connected with one another, in the region of ring belt 15, by way of a joining seam 227, which runs horizontally through top land 14 above ring belt 15. With regard to the further structure of piston 210 and its function, reference is made to the description regarding FIG. 1.

Accordingly, while only a few embodiments of the present invention have been shown and described, it is obvious that many changes and modifications may be made thereunto without departing from the spirit and scope of the invention.

What is claimed is:

1. A piston for an internal combustion engine, comprising:
a piston crown;
a circumferential ring belt connected to the piston crown;
a circumferential cooling channel in a region of the ring belt;
pin boss supports connected below the piston crown;
pin bosses connected with the pin boss supports; and
a piston skirt;
wherein a cavity closed all around is provided below the piston crown and wherein a coolant in the form of a metal having a low melting point or a metal alloy having a low melting point is accommodated in the cavity.

2. The piston according to claim 1, wherein the coolant is sodium or potassium.

3. The piston according to claim 1, wherein the coolant is a metal alloy selected from the group consisting of Galinstan® alloys, bismuth alloys having a low melting point, and sodium-potassium alloys.

4. The piston according to claim 1, wherein a volume of the coolant accommodated in the cavity amounts to at most 10% of a volume of the cavity.

5. The piston according to claim 1, wherein a combustion bowl made of a heat-resistant steel or a nickel-based alloy is provided in the piston crown.

6. The piston according to claim 1, wherein the piston crown consists of a heat-resistant steel or a nickel-based alloy.

7. The piston according to claim 1, wherein the piston crown and at least part of the circumferential ring belt consist of a heat-resistant steel or a nickel-based alloy.

8. The piston according to claim 1, wherein the piston is configured as a one-part or multi-part piston.
